(19) United States
(12) Patent Application Publication
(10) Pub. No.: US 2013/0319029 A1
(43) Pub. Date: Dec. 5, 2013

(54) VEHICLE THERMAL SYSTEM

(71) Applicants: Sachio Sekiya, Hitachinaka (JP); Hiroaki Matsushima, Seika (JP); Tadashi Osaka, Kashiwa (JP); Yuki Akiyama, Hitachinaka (JP); Riichi Uchida, Kasama (JP)

(72) Inventors: Sachio Sekiya, Hitachinaka (JP); Hiroaki Matsushima, Seika (JP); Tadashi Osaka, Kashiwa (JP); Yuki Akiyama, Hitachinaka (JP); Riichi Uchida, Kasama (JP)

(73) Assignee: HITACHI, LTD., Tokyo (JP)

(21) Appl. No.: 13/985,380

(22) PCT Filed: Feb. 22, 2011
(86) PCT No.: PCT/JP2011/053755

§ 371 Date: Aug. 14, 2013

(51) Int. Cl. B60H 1/00

(52) U.S. Cl. CPC B60H 1/00021
USPC 62/238.7

(57) ABSTRACT

A vehicle thermal system includes a heat pump system in which a compressor, a first refrigerant switching unit configured to switch a flowing direction of a refrigerant, an outdoor heat exchanger, a first flow rate control unit, a second flow rate control unit, and a heat pump intermediate heat exchanger are connected in order, and which has a bypass circuit including a third flow rate control unit between the first flow rate control unit and the second flow rate control unit, a heat pump indoor heat exchanger, and a second refrigerant switching unit configured to switch between a discharge side of the compressor and an suction side of the compressor. The heat pump system has the refrigerant flowing therein and a heat medium circuit in which a liquid pump, a cooling heat exchanger, a heat medium indoor heat exchanger and a heat medium intermediate heat exchanger are sequentially connected.

### TECHNICAL FIELD

The present invention relates to a vehicle thermal system applied to an electric-powered vehicle such as electric car, hybrid car or electric railway.

### BACKGROUND ART

With respect to a vehicle thermal system for an electric car or the like, for example, the techniques described in Patent Literature 1 and Patent Literature 2 are known.

Patent Literature 1 describes a vehicle air conditioning apparatus including: a HVAC unit which blows out, into the interior of the vehicle, air that is temperature-adjusted by a refrigerant evaporator, an air mixing damper and a heat medium heater arranged in an air passage; a heat pump cycle in which a refrigerant compressor, a refrigerant circulation switching unit configured to switch the circulating direction of the refrigerant, an air heat exchanger which performs heat exchange between the refrigerant and the outside air, a refrigerant expansion unit, and the refrigerant evaporator are connected in this order, and in which a refrigerant/heat medium heat exchanger which performs heat exchange between the refrigerant and the heat medium is connected in parallel to the refrigerant evaporator; and a heat medium cycle in which a heat medium circulation pump, the refrigerant/heat medium heat exchanger, an electric heater for heating the heat medium, and the heat medium heater are connected in this order; wherein a cooling circuit for a traveling motor is connected in parallel to the heat medium cycle via a solenoid valve, and the heat medium in the cooling circuit can circulate into the heat medium heater via the heat medium pump.

Patent Literature 2 describes a vehicle air-conditioning apparatus including: a duct for feeding air into the interior of a vehicle; a blower which blows the air in the duct into the interior of the vehicle; a refrigerant cycle including a refrigerant compressor which compresses and then ejects a refrigerant, a refrigerant water heat exchanger which performs heat exchange between the refrigerant ejected by this refrigerant compressor and hot water and thus heats the hot water, and a refrigerant evaporator which cools the air with evaporation heat of the refrigerant; and a hot water cycle including a pump which causes the hot water heated by the refrigerant water heat exchanger to circulate, and a hot water heater which is installed in the duct and heats the air flowing through the duct, with the hot water flowing in from the refrigerant water heat exchanger.

### CITATION LIST

### Patent Literature

PTL 1: JP-A-2009-280020
PTL 2: JP-A-8-197937

### SUMMARY OF INVENTION

### Technical Problem

The techniques described in Patent Literature 1 and Patent Literature 2 employ a system in which at the time of indoor cooling, the heat medium heater is cooled with the cool air cooled by the refrigerant evaporator (equivalent to a “heat pump indoor heat exchanger” of the invention), whereas at the time of indoor heating, the heat medium is heated by the refrigerant/heat medium heat exchanger (equivalent to a “heat pump intermediate heat exchanger” of the invention) and the air is heated by the heat medium heater. Therefore, since the temperature of the heat medium for indoor heating and for indoor cooling is the same, there is a problem that fine temperature control cannot be carried out.

An object of the invention is to provide a vehicle thermal system which can solve the problem of the related-art techniques, constantly maintain the temperature of a heating element installed in a vehicle in a wide variety of environments from low outside temperature to high outside temperature, and carry out indoor cooling or heating of the vehicle securely.

### Solution to Problem

(1) The invention of claim 1 is a vehicle thermal system characterized by including: a heat pump system in which a compressor, a first refrigerant switching unit configured to switch a flowing direction of a refrigerant, an outdoor heat exchanger, a first flow rate control unit, a second flow rate control unit, and a heat pump intermediate heat exchanger are connected in this order, and which has a bypass circuit including a third flow rate control unit between the first flow rate control unit and the second flow rate control unit, a heat pump indoor heat exchanger, and a second refrigerant switching unit configured to switch between an discharge port of the compressor and an suction port of the compressor, the heat pump system having the refrigerant flowing therein; and a heat medium circuit in which a liquid pump, a cooling heat exchanger which cools a heating element installed in the vehicle, a heat medium indoor heat exchanger and a heat medium intermediate heat exchanger are sequentially connected, the heat medium circuit having the heat medium flowing therein, wherein the heat pump intermediate heat exchanger and the heat medium intermediate heat exchanger are provided in a heat-exchangeable manner.

(2) According to the invention of claim 2, the vehicle thermal system according to claim 1 is characterized in that: the heat medium indoor heat exchanger includes a first heat medium indoor heat exchanger, and a second heat medium indoor heat exchanger arranged downstream of an air flow passing through the first heat medium indoor heat exchanger; an air duct switching unit which directs the air flow passing through the first heat medium indoor heat exchanger, toward the second heat pump indoor heat exchanger or outward, is provided; and the second heat medium indoor heat exchanger is provided downstream of the air flow passing through the heat pump indoor heat exchanger.

(3) According to the invention of claim 3, the vehicle thermal system according to claim 1 is characterized in that, as a cooling heat exchanger of the heating element, a bypass passage is provided in which a battery heat exchanger, an inverter heat exchanger, a voltage converter heat exchanger, a motor heat exchanger and a transmission heat exchanger are connected in series and in which a flow rate of the heat medium is controlled with respect to each of the battery heat exchanger, the voltage converter heat exchanger and the transmission heat exchanger.

(4) According to the invention of claim 4, the vehicle thermal system according to claim 1 is characterized in that: a second heat medium circuit that is independent of the heat medium circuit where the heat medium flows is provided; the second heat medium circuit is provided with a combustor which heats a second heat medium flowing through the circuit, and an auxiliary indoor heating heat exchanger; and the auxiliary indoor heating heat exchanger and the heat medium intermediate heat exchanger are provided in a heat-exchangeable manner.

(5) According to the invention of claim 5, the vehicle thermal system according to claim 4 is characterized in that the heat pump intermediate heat exchanger, the heat medium intermediate heat exchanger and the auxiliary indoor heating heat exchanger are provided in a heat-exchangeable manner by a pressing force and are configured to be separable from one another when the pressing force is eliminated.

### Advantageous Effect of Invention

According to the invention, since temperature control of the heating element installed in the vehicle is made easier irrespective of the air conditioning load in the interior of the vehicle, proper cooling of the heating element can be carried out securely.

According to the invention, the waste heat of the heating element installed in the vehicle can be effectively utilized for indoor heating of the vehicle. Also, by setting the air duct outside when the air conditioning is stopped or at the time of indoor cooling, the air heated by the first heat medium indoor heat exchanger is discharged outside and therefore this air can be prevented from being introduced indoors.

According to the invention, by providing the cooling heat exchanger with the bypass passage provided with the flow rate control unit configured to control the flow rate of the heat medium, even when the heat medium flow rate necessary for cooling varies, the heat medium is made to flow in the bypass passage at the flow rate for other machines in accordance with the flow rate corresponding to a machine that uses a maximum heat medium flow rate.

According to the invention, by preferentially cooling the electronic components of the battery, the inverter and the voltage converter, reliability of the electronic components with relatively low heat resistance is increased. Also, with respect to the machines with an optimum temperature range in view of efficiency and reliability, such as the battery and the transmission, optimum operation with high efficiency and high reliability can be constantly secured by controlling the heat medium flow rate.

According to the invention, by providing the auxiliary indoor heating device and providing the auxiliary indoor heating heat exchanger and the heat medium intermediate heat exchanger in a heat-exchangeable manner, even when the outside temperature is low, indoor heating capability is secured. Also, the consumption of the battery due to indoor heating is restrained and the traveling distance of the vehicle can be secured.

According to the invention, by making the separable heat pump intermediate heat exchanger, the heat medium intermediate heat exchanger and the auxiliary indoor heating heat exchanger, these heat exchangers can be easily installed later if the auxiliary indoor heating device is needed. Also, even if a failure occurs in the auxiliary heating device and the heat medium circuit, these can be easily detached from the heat pump system. The refrigerant enclosed in the heat pump system need not be collected and global warming due to the emission of the refrigerant in the atmosphere can be prevented.

### BRIEF DESCRIPTION OF DRAWINGS

FIG. 1 It shows the schematic configuration of a vehicle thermal system of the invention.

FIG. 2 It shows the configuration of a heat pump intermediate heat exchanger 19 according to the invention.

FIG. 3 It shows indoor cooling/heating and cooling/warm-up state or operation conditions of components.

FIG. 4 It shows the vehicle thermal system of the invention in a cooling operation mode.

FIG. 5 It shows the vehicle thermal system of the invention in a cooling-indoor cooling operation mode.

FIG. 6 It shows the vehicle thermal system of the invention in a cooling-indoor heating operation mode.

FIG. 7 It shows the vehicle thermal system of the invention in a dehumidifying operation mode.

FIG. 8 It shows the vehicle thermal system of the invention in a warm-up operation mode.

FIG. 9 It shows the vehicle thermal system of the invention in an auxiliary indoor heating operation mode.

### DESCRIPTION OF EMBODIMENTS

Hereinafter, an embodiment in which a vehicle thermal system of the invention is applied to an electric car will be described. However, the scope of the invention is not limited to this. Also, the invention is not limited to an electric car and can also be applied to electric-powered vehicles such as hybrid cars, electric railways, construction vehicles and other special vehicles. Also, though this embodiment is described taking a motor driven by an inverter as an example, the invention is not limited to a motor driven by an inverter and can also be applied to any kind of revolving electric motor (motor generator) such as a DC motor driven by a converter, for example, a thyristor Leonard device or the like, or a pulse motor driven by a chopper power supply.

### (1) Configuration of Vehicle Thermal System

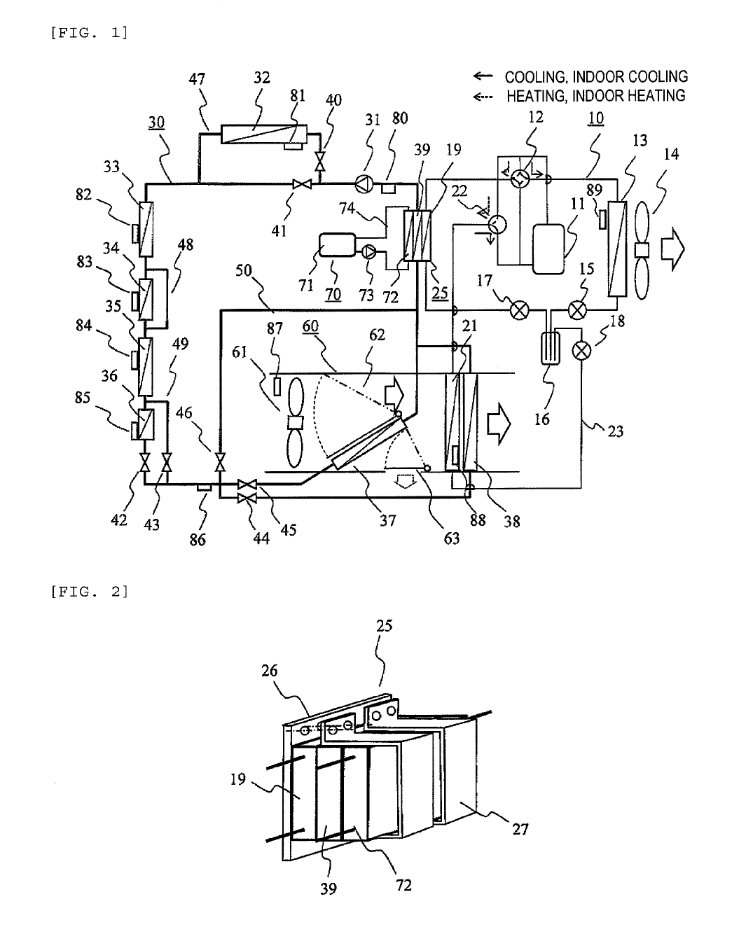

FIG. 1 is a view showing the schematic configuration of a vehicle thermal system of the invention. The vehicle thermal system shown in FIG. 1 includes an indoor air conditioning unit 60 for carrying out indoor cooling/heating and cooling/heating of the interior of a vehicle and machines that need temperature adjustment, a heat pump system 10, a heat medium circuit 30 for adjusting the temperature of a heating element installed in the vehicle, and an air conditioning controller (not shown) which controls these units.

Various actuators provided in the vehicle thermal system are controlled by a control signal from the air conditioning controller. The actuators according to this embodiment include a compressor 11, an expansion valve A 15 as a first flow rate control unit, an expansion valve B 17 as a second flow rate control unit, an expansion valve C 18 as a third flow rate control unit, a four-way valve 12 as a first refrigerant switching unit, a three-way valve 22 as a second refrigerant switching unit, a two-way valve A 40, a two-way valve B 41, a two-way valve C 42, a two-way valve D 43, a two-way valve E 44, a two-way valve F 45, a two-way valve G 46, an outdoor fan 14 and an indoor fan 61.

In a heat medium circuit 30, a heat medium (for example, an ethylene glycol solution) is sent out by a pump 31 and cools heating elements installed in the vehicle (in the example shown in FIG. 1, a battery, an inverter, a voltage converter, a motor, a transmission). The heat medium, thus having a temperature rise, can properly heat the air sent into the interior of the vehicle and further circulates back to the pump 31 via a heat medium intermediate heat exchanger. Also, a heat medium temperature sensor 80 which detects the temperature of the heat medium, and a battery temperature sensor 81, an inverter temperature sensor 82, a voltage converter temperature sensor 83, a motor temperature sensor 84 and a transmission temperature sensor 85 which detect the temperatures of the respective heating elements are provided.

Meanwhile, in a refrigerant cycle of the heat pump system 10, the compressor 11 which compresses a refrigerant (for example, R1234yf), an outdoor heat exchanger 13 which performs heat exchange between the refrigerant and the outside air, a heat pump intermediate heat exchanger 19 located in a branch refrigerant cycle circuit, and a heat pump indoor heat exchanger 21 which performs heat exchange between the refrigerant and the indoor air are provided.

The four-way valve 12 is provided between a suction pipe and a discharge pipe of the compressor 11. By switching the four-way valve 12, one of the suction pipe and the discharge pipe is connected to the outdoor heat exchanger 13 and the other is connected to the heat pump intermediate heat exchanger 19. Also, by switching the three-way valve 22, the heat pump indoor heat exchanger 21 is connected to one of the suction side and the discharge side of the compressor 11.

Also, a receiver tank 16 for storing an excess refrigerant in the form of liquid is provided between the expansion valve A 15 and the expansion valve B 17. A bypass circuit is provided from the receiver tank 16 to the expansion valve C 18. Moreover, an indoor unit inflow air temperature sensor 87 which detects the temperature of the air flowing into the indoor air conditioning unit 60, a heat pump indoor heat exchanger temperature sensor 88 which detects the temperature of the heat pump indoor heat exchanger 21, and an outside air temperature sensor 89 which detects the temperature of the outside air are provided. The air conditioning load is calculated based on the temperature difference between the preset temperature of the air conditioning controller and the indoor temperature (not shown) and the outside air temperature calculated by the outside air temperature sensor 89.

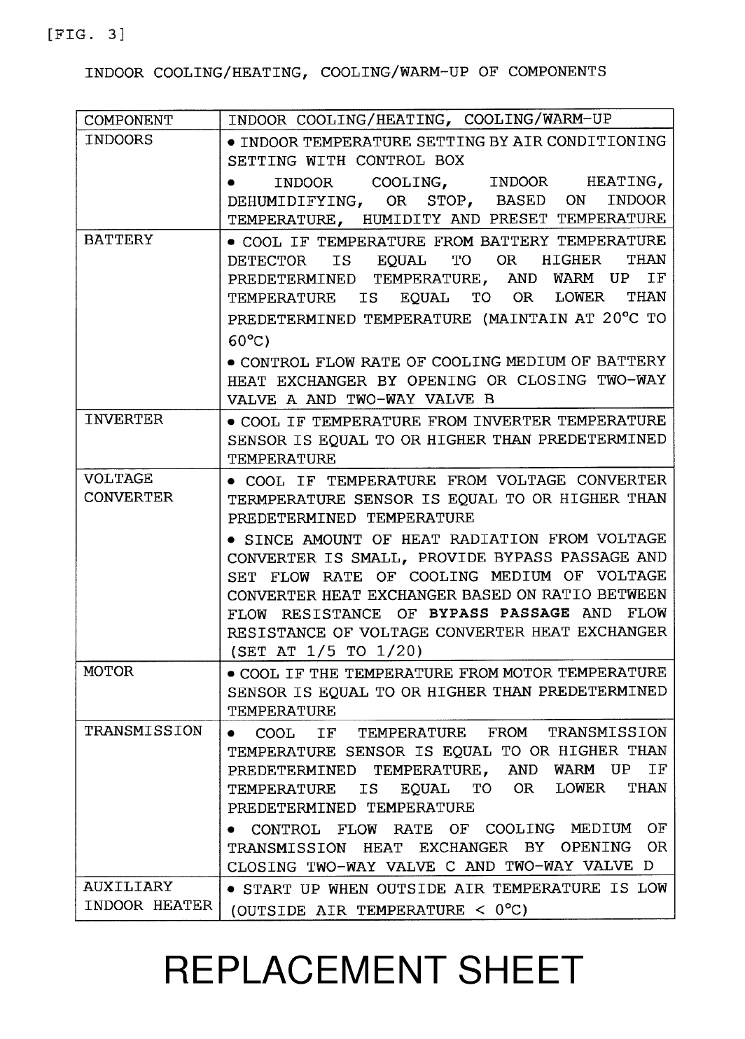

FIG. 2 shows the configuration of an intermediate heat exchanger 25 according to the invention. The intermediate heat exchanger 25 is configured by housing the heat pump intermediate heat exchanger 19, a heat medium intermediate heat exchanger 39 and an auxiliary indoor heating heat exchanger 72 within a heat exchanger holding frame 27 with these heat exchangers being in contact with one another in a heat-exchangeable manner, and fixing the holding frame 27 to a heat exchanger attaching unit 26. On the other hand, when the holding frame 27 is released from the heat exchanger attaching unit 26, the heat pump intermediate heat exchanger 19, the heat medium intermediate heat exchanger 39 and the auxiliary indoor heating heat exchanger 72 are separable from one another.

### (2) Indoor Cooling/Heating, Cooling/Warm-Up Operation of Components

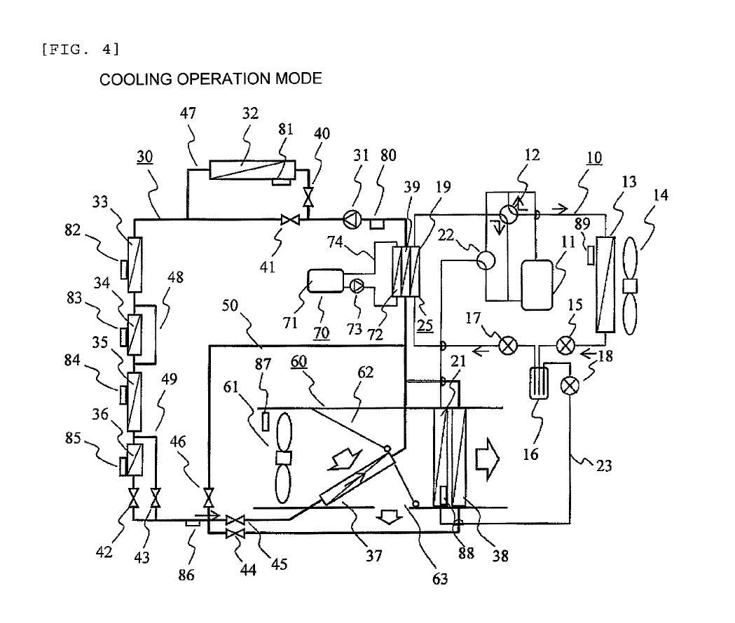

FIG. 3 shows conditions of indoor cooling/heating and cooling/warm-up with respect to components of the vehicle thermal system according to the invention.

Next, operations of the vehicle thermal system shown in FIG. 1 will be described in order. Hereinafter, cooling, cooling and indoor cooling, cooling and indoor heating, cooling and dehumidifying, warm-up, and auxiliary indoor heating operations will be described.

### (3) Cooling Operation Mode

A cooling operation mode is a mode that is automatically driven when at least one of the temperatures detected by the battery temperature sensor 81, the inverter temperature sensor 82, the voltage converter temperature sensor 83, the motor temperature sensor 84, the transmission temperature sensor 85 and the heat medium temperature sensor 80, which detect the temperatures of the respective heating elements, exceeds a first preset temperature that is set for each heating element in the state where the indoor air conditioning is stopped.

FIG. 4 is used for the explanation. When the temperature of the heat medium detected by the heat medium temperature sensor 80 becomes equal to or higher than the lowest temperature of the first preset temperatures set for the respective heating elements, the operation is controlled to start a ventilating-cooling operation mode. The pump 31 is controlled to operate. An air duct switching device A 62 is controlled toward a heating medium first heat exchanger 37. An air duct switching device B 63 is controlled toward the outside. The two-way valve E 44 and the two-way valve G 46 are controlled to close. The two-way valve F 45 is controlled to open. The indoor fan 61 is operated.

As the pump 31 is operated, the heat medium (for example, an ethylene glycol solution) in the heat medium circuit 30 circulates and the heat medium flows through an inverter heat exchanger 33, a voltage converter heat exchanger 34, a motor heat exchange 35 and a transmission heat exchanger 36, thus cooling these heating elements. At this time, the battery and the transmission, in which a proper value is set with respect to the efficiency of the heating elements in view of the temperature, are provided with a battery bypass passage 47 and a transmission bypass passage 49, respectively, and the two-way valve A 40, the two-way valve B 41, the two-way valve C 42 and the two-way valve D 43 are able to control the flow rate. When the battery temperature detected by the battery temperature sensor 81 is equal to or lower than a first battery preset value (for example, 40° C.), the two-way valve A 40 closes and the two-way valve B 41 opens. The heat medium flows through the battery bypass passage 47 and the temperature of the battery rises because of the heat generation of the battery. When the temperature becomes equal to or higher than a second battery preset temperature (for example, 60° C.), the two-way valve A 40 opens and the two-way valve B 41 closes. The heat medium flows through a battery heat exchanger 32, thus cooling the battery. Therefore, the temperature of the battery can be maintained constantly at a temperature that realizes high discharge efficiency.

Also, the temperature of the transmission is controlled within a predetermined range by the transmission bypass passage 49, the two-way valve C 42 and the two-way valve D 43 and the viscosity of a lubricant enclosed in the transmission is maintained at a proper value. Thus, both reliability and efficiency can be realized. Meanwhile, with respect to the voltage converter, in which the amount of heat generation is small and there is small change in efficiency at low temperatures, a proper flow rate of the heat medium flowing through the voltage converter heat exchanger 34 can be realized by providing a voltage converter bypass passage 48, and the pressure loss of the heat medium in the voltage converter heat exchanger 34 can be reduced.

The heat medium heated by the heating elements passes through the two-way valve F, is cooled by the air fed by the indoor fan 61, passes through the heat medium intermediate heat exchanger 39, and returns to the pump 31 again. The air, cooling the heat medium and thus getting heated, is discharged outward by the air duct switching device B 63. Here, if the indoor unit inflow air temperature detected by the indoor unit inflow air temperature sensor 87 is low and the heat medium is excessively cooled, the temperature of the heat medium can be maintained properly by opening the two-way valve B and thus reducing the flow rate of the heat medium flowing through the heat medium intermediate heat exchanger 39.

When the amount of heat generation of the heating machine increases, or the outside air temperature rises and the temperature of the heat medium detected by the heat medium temperature sensor 80 becomes equal to or higher than the lowest temperature of the second preset values that are set for the respective heating elements, a forced cooling mode begins. The four-way valve 12 is controlled toward the cooling. The three-way valve 22 is controlled toward the indoor cooling. The expansion valve C 18 is controlled to close completely. The outdoor fan 14 is controlled to operate. The heat pump system. 10 is driven. The heat medium circuit 30 and the indoor air conditioning unit are controlled in the same manner as in the ventilating-cooling mode.

The refrigerant in the heat pump system 10 becomes a high-temperature high-pressure gas refrigerant in the compressor 11 and is sent to the outdoor heat exchanger 13 through the four-way valve 12. In the outdoor heat exchanger 13, the refrigerant radiates heat into the air supplied by the outdoor fan 14 and thus becomes a liquid refrigerant, then is decompressed by the expansion valve A 15 and thus becomes a saturated liquid refrigerant, and is sent to the receiver tank 16. The liquid refrigerant in the receiver tank 17 is sent to the expansion valve B 17 and further decompressed to become a low-pressure low-temperature two-phase refrigerant. The refrigerant is sent to the heat pump intermediate heat exchanger 19 in the intermediate heat exchanger 25, cools the heat medium intermediate heat exchanger 39 in surface contact thereto within the holding frame 27, becomes a low-pressure gas refrigerant and returns to the compressor 11 through the four-way valve 12.

Therefore, the heat medium is cooled by the air supplied by the indoor fan 61 as in the ventilating-cooling mode, and is also cooled in the intermediate heat exchanger 25 by the heat pump system 10. When the temperature becomes equal to or lower than the second preset temperature, the operation is controlled again to start the ventilating-cooling mode. Since the rotational speed of the compressor 11 is controlled according to the temperature of the heat medium, the cooling capability can be controlled according to the amount of heat generation of the heating machine and cooling can be carried out securely. Moreover, by forming the heat pump intermediate heat exchanger and the heat medium intermediate heat exchanger as separable structures and providing these heat exchangers in a heat-exchangeable manner using the holding frame, even if a failure occurs in the heat medium circuit and the heat medium circuit needs to be detached, there is no need to detach the heat pump system and leakage can be prevented at the time of refrigerant recovery.

### (4) Cooling-Indoor Cooling Operation Mode

A cooling-indoor cooling operation mode is a mode that is automatically driven when indoor cooling operation is selected by the air conditioning controller and at least one of the temperatures detected by the battery temperature sensor 81, the inverter temperature sensor 82, the voltage converter temperature sensor 83, the motor temperature sensor 84, the transmission temperature sensor 85 and the heat medium temperature sensor 80, which detect the temperatures of the respective heating elements, exceeds the first preset temperature that is set for each heating element.

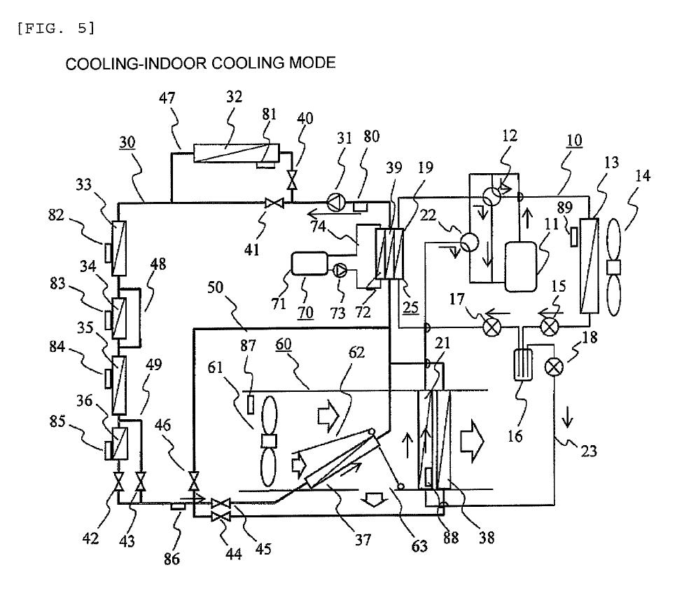

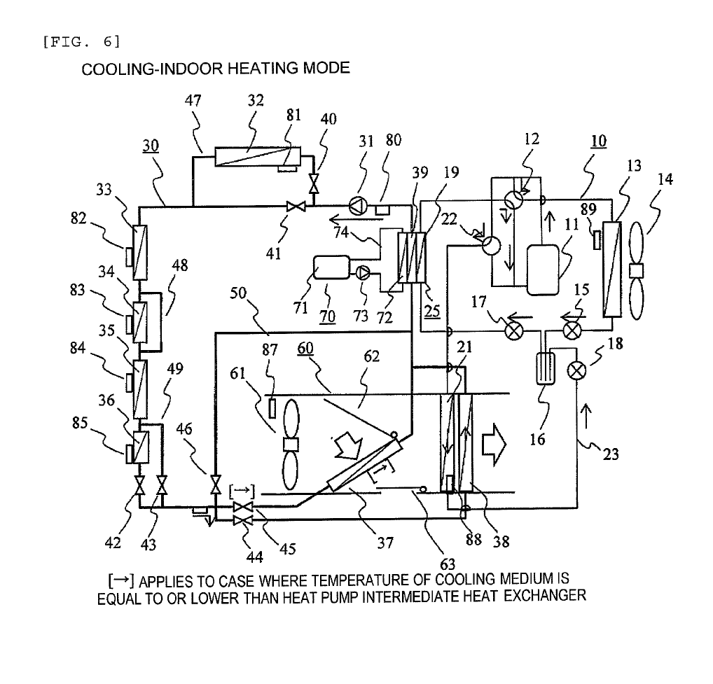

Referring to FIG. 5 for the explanation, the four-way valve 12 of the heat pump system 10 is switched toward the cooling to connect the discharge side of the compressor to the outdoor heat exchanger 13, and the three-way valve 22 is switched toward the indoor cooling. The expansion valve C 18 is controlled to be a preset opening level. The compressor 11 and the outdoor fan 14 are driven. Moreover, the pump 31 of the heat medium circuit 30 and the indoor fan 61 of the indoor air conditioning unit 60 are driven. The air duct switching device A 62 is controlled to an intermediate position. The air duct switching device B 63 is controlled toward the outside air.

As the compressor 11 is driven, the refrigerant in the heat pump system 10 becomes a liquid refrigerant in the outdoor heat exchanger 13 and is sent in a saturated liquid state to the receiver tank 16. The saturated liquid refrigerant is decompressed by the expansion valve C 18 and thus becomes a low-pressure low-temperature two-phase refrigerant. The refrigerant is sent to the heat pump intermediate heat exchanger 21, cools the air supplied by the indoor fan 61, becomes a gas refrigerant and returns to the compressor through the three-way valve 22. The air cooled in the heat pump intermediate heat exchanger 21 flows out indoors and cools the interior.

Meanwhile, the heat medium is made to flow in the heat medium circuit 30 by the pump 31 and cools each heating machine, thus having a temperature rise. The heat medium passes through the two-way valve F 45 and radiates heat into the air diverged by the air duct switching device B 62 in the heat medium first heat exchanger 37, thereby getting cooled.

When the temperature of the heat medium becomes equal to or higher than the second preset temperature, the expansion valve B 17 is opened to a preset opening level. As the expansion valve B 17 is opened, a part of the liquid refrigerant in the receiver tank 16 is decompressed by the expansion valve B 17, flows into the heat pump intermediate heat exchanger 19, cools the heat medium flowing through the heat medium intermediate heat exchanger 39, passes through the four-way valve 12, joins the refrigerant flowing through the heat pump intermediate heat exchanger 21 and the three-way valve 22, and returns to the compressor 11. The rotational speed of the compressor and the opening level of the expansion valve B 17 and the expansion valve C 18 are set according to the temperature of the heat medium and the indoor air conditioning load. Therefore, the cooling of the heat medium and the indoor cooling operation can be realized simultaneously.

When the temperature of the heat medium becomes equal to or lower than the second preset value, the expansion valve B 17 completely closes and the heat medium circuit 30 enters the ventilating-cooling mode. Moreover, when the temperature of the heat medium falls and all the temperatures detected by the battery temperature sensor 81, the inverter temperature sensor 82, the voltage converter temperature sensor 83, the motor temperature sensor 84, the transmission temperature sensor 85 and the heat medium temperature sensor 80, which detect the temperatures of the respective heating elements, become equal to or lower than the first preset temperature that is set for each heating element, the pump 31 stops and the air duct switching device A 62 is switched toward the heat pump indoor heat exchanger. All the air from the indoor fan 61 is sent to the heat pump indoor heat exchanger 21 and the operation is controlled to start an indoor cooling operation mode in which the interior is cooled.

### (5) Cooling-Indoor Heating Operation Mode

A cooling-indoor heating operation mode is a mode that is automatically driven when indoor heating operation is selected by the air conditioning controller and at least one of the temperatures detected by the battery temperature sensor 81, the inverter temperature sensor 82, the voltage converter temperature sensor 83, the motor temperature sensor 84, the transmission temperature sensor 85 and the heat medium temperature sensor 80, which detect the temperatures of the respective heating elements, exceeds the first preset temperature that is set for each heating element.

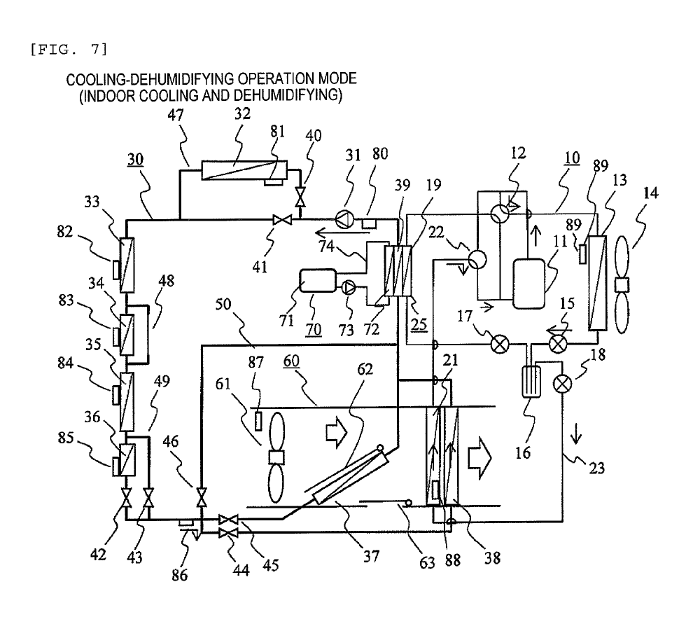

Referring to FIG. 6 for the explanation, the four-way valve 12 of the heat pump system 10 is switched toward the cooling and the discharge side of the compressor is connected to the outdoor heat exchanger 13, and the three-way valve 22 is switched toward the indoor heating. The expansion valve C 18 is controlled to a preset level. The compressor 11 and the outdoor fan 14 are driven. Moreover, the pump 31 of the heat medium circuit 30 and the indoor fan 61 of the indoor air conditioning unit 60 are driven. The air duct switching device A 62 is controlled toward the heat medium first heat exchanger 37. The air duct switching device B 63 is controlled toward the heat pump indoor heat exchanger. The two-way valve G 46 is controlled to close.

The two-way valve E 44 and the two-way valve F 45 are controlled according to the temperature of the heat medium flowing into the indoor air conditioning unit 60 detected by an indoor air conditioning unit entrance heat medium temperature sensor 86 and the temperature of the heat pump intermediate heat exchanger detected by a heat pump intermediate heat exchanger temperature sensor 88. When the heat medium temperature is higher than the temperature of the heat pump intermediate heat exchanger, the two-way valve E 44 is controlled to open and the two-way valve F 45 is controlled to close. If lower, the two-way valve E 44 is controlled to close and the two-way valve F 45 is controlled to open.

As the compressor 11 is driven, the refrigerant, becomes high-temperature and high-pressure in the compressor 11, is sent to the heat pump indoor heat exchanger 21 through the three-way valve 22, heats the air supplied by the indoor fan 61, becomes a saturated liquid at the expansion valve C 18, and is sent to the receiver tank 16. The refrigerant from the receiver tank 16, decompressed by the expansion valve A 15 to become low-pressure, low-temperature and two-phase, absorbs heat from the air supplied by the outdoor fan 14 in the outdoor heat exchanger 13, becomes a gas refrigerant, and returns to the compressor through the four-way valve 12.

The heat medium in the heat medium circuit, cooling the heating machine and thus having a temperature rise, passes through the two-way valve E 44 if the temperature of the heat medium is higher than the temperature of the heat pump intermediate heat exchanger, and further heats the air heated by the heat pump indoor heat exchanger 21 at a heat medium second heat exchanger 38, thus getting cooled. If the temperature of the heat medium is lower than the temperature of the heat pump intermediate heat exchanger, the heat medium passes through the two-way valve F 45 and heats the air supplied by the indoor fan 61 at the heat medium first heat exchanger 37, thus getting cooled.

By using the heat radiation from the heating machine for indoor heating as described above, the necessary amount of heat in the heat pump system can be reduced and the power consumption by the heat pump system can be cut. Also, by switching the heat radiation from the heating machine before or after the heat pump indoor heat exchanger according to the temperature of the heat medium and the temperature of the heat pump intermediate heat exchanger, the amount of heat radiation can be utilized for indoor heating even if the amount of heat radiation from the heating machine is small and the temperature of the heat medium is lower than the temperature of the heat pump intermediate heat exchanger. On the other hand, if the temperature of the heat medium is higher than the temperature of the heat pump intermediate heat exchanger, the temperature of the air heated by the heat pump system can be lowered. The efficiency of the heat pump system improves and the power consumption can be reduced.

### (6) Dehumidifying Operation Mode and Indoor Heating Operation Mode

A dehumidifying operation mode is a mode that is automatically driven when dehumidifying operation is selected by the air conditioning controller. At this time, if the indoor preset temperature is lower than the indoor temperature, the operation is controlled to the indoor cooling and dehumidifying. If the indoor preset temperature is higher than the indoor temperature, the operation is controlled to the indoor heating and dehumidifying.

Referring to FIG. 7 to explain the dehumidifying operation, the four-way valve 12 of the heat pump system 10 is switched toward the cooling. The three-way valve 22 is switched toward the indoor cooling. The expansion valve B 17 is controlled to close. The compressor 11 and the outdoor fan 14 are driven. Moreover, the pump 31 of the heat medium circuit 30 and the indoor fan 61 of the indoor air conditioning unit 60 are driven. The air duct switching device A 62 is controlled toward the heat pump indoor heat exchanger. The air duct switching device B 63 is controlled toward the heat pump indoor heat exchanger. The two-way valve E 44 is controlled to open. The two-way valve F 45 and the two-way valve G 46 are controlled to close.

As the compressor 11 is driven, the refrigerant, rendered becomes high-temperature and high-pressure in the compressor 11, passes through the four-way valve 12, radiates heat in the outdoor heat exchanger 13, passes through the expansion valve A 15 and is sent as a saturated liquid to the receiver tank 16. The liquid refrigerant in the receiver tank 16 is decompressed by the expansion valve C 18, becomes a low-pressure low-temperature two-phase refrigerant and is sent to the heat pump intermediate heat exchanger 21. The refrigerant cools the air supplied by the indoor fan 61, becomes a gas refrigerant, and returns to the compressor 11 through the three-way valve 22. The heat medium in the heat medium circuit, sent to each heat exchanger of the heating machines by the pump 31 and thus having a temperature rise, passes through the two-way valve E 44 and heats again the air cooled by the heat pump indoor heat exchanger 21 at the heat medium second heat exchanger 38. The heat medium is thus cooled and returns to the pump 31 through the heat medium intermediate heat exchanger 39.

Therefore, the air supplied by the indoor fan 61 is cooled by the heat pump indoor heat exchanger 21 and condenses the moisture, thus getting dehumidified. As the air is heated again by the heat medium intermediate heat exchanger 38, the air flows out indoors with low humidity and at relatively low temperature and thus caries out indoor dehumidifying and indoor cooling. The rotational speed of the compressor 11 is controlled according to the temperature of the heat medium detected by the indoor unit inflow heat medium temperature sensor 86, the temperature of indoor fan inflow air detected by the indoor unit inflow air temperature sensor 87 and the indoor air conditioning load.

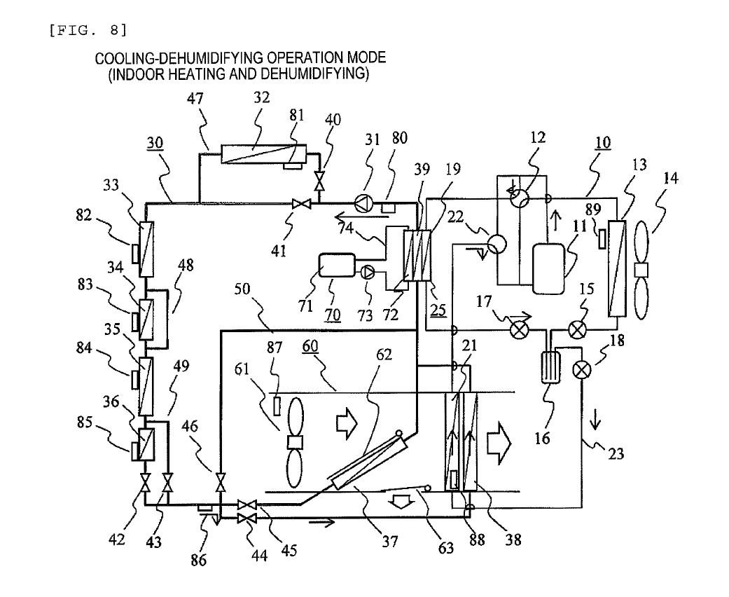

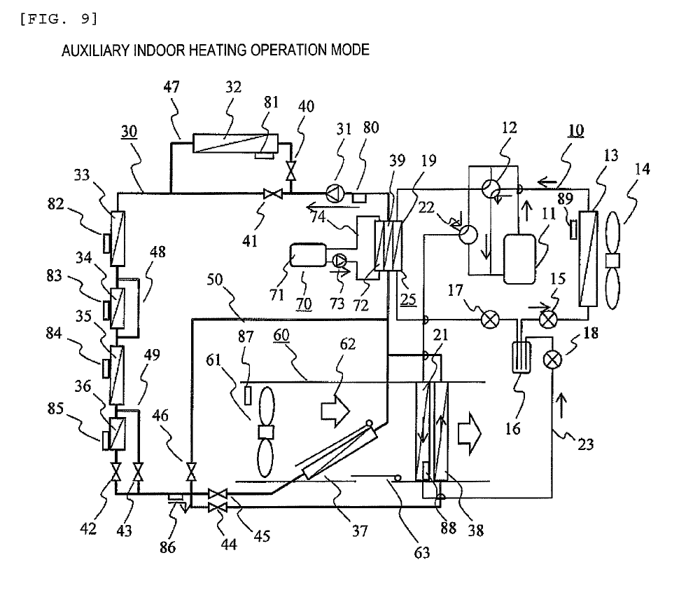

Next, the indoor heating and dehumidifying will be described with reference to FIG. 8. The four-way valve 12 of the heat pump system 10 is switched toward the heating. The three-way valve 22 is switched toward the indoor cooling. The expansion valve A 15 is controlled to close. The compressor 11 and the outdoor fan 14 are driven. Moreover, the pump 31 of the heat medium circuit 30 and the indoor fan 61 of the indoor air conditioning unit 60 are driven. The air duct switching device A 62 is controlled toward the heat pump indoor heat exchanger. The air duct switching device B 63 is controlled toward the heat pump indoor heat exchanger. The two-way valve E 44 is controlled to open. The two-way valve F 45 and the two-way valve G 46 are controlled to close.

As the compressor 11 is driven, the refrigerant, becomes high-temperature and high-pressure in the compressor 11, passes through the four-way valve 12, heats the heat medium flowing through the heat medium intermediate heat exchanger 39 in the heat pump intermediate heat exchanger 19 and thus becomes a liquid refrigerant, and is sent to the receiver tank 16 as a saturated liquid via the expansion valve B 17. The liquid refrigerant in the receiver tank 16 is decompressed by the expansion valve C 18, becomes a low-pressure low-temperature two-phase refrigerant, is sent to the heat pump intermediate heat exchanger 21, cools the air fed by the indoor fan 61, becomes a gas refrigerant, and returns to the compressor 11 via the three-way valve 22. The heat medium in the heat medium circuit, sent to each heat exchanger of the heating machines by the pump 31 and thus having a temperature rise, passes through the two-way valve E 44 and heats again the air cooled by the heat pump indoor heat exchanger 21 at the heat medium second heat exchanger 38, thus getting cooled. The heat medium is heated by the heat pump intermediate heat exchanger 19 at the heat medium intermediate heat exchanger 39 and returns to the pump 31.

Therefore, in the heating of the heat medium, the amount of heat radiation from the heat pump system 10 is added to the amount of heat radiation from the heating element, and this amount is necessarily larger than the amount of cooling by the heat pump intermediate heat exchanger 21. The air supplied by the indoor fan 61 is cooled by the heat pump indoor heat exchanger 21 and condenses the moisture, thus getting dehumidified. The air is heated again by the heat medium intermediate heat exchanger 38, thus flows out indoors with low-humidity and at relatively high temperature, and performs the dehumidification and heating indoors. The rotational speed of the compressor 11 is controlled according to the temperature of the heat medium detected by the indoor unit inlet heat medium temperature sensor 86, the temperature of the inflow air from the indoor fan 87 detected by the indoor unit inflow temperature sensor 87, and the indoor air conditioning load.

A warm-up operation mode will be described with reference to FIG. 8. The warm-up mode takes place immediately after the vehicle starts up when the outer temperature is low, such as in winter. If the temperature of the heat medium detected by the heat medium temperature sensor 80 is equal to or lower than a third preset value (for example, 20° C.), the operation is controlled to start the warm-up mode. Here, when dehumidification is set by the air conditioning controller, the heat pump system 10, the heat medium circuit 30 and the indoor air conditioning unit 60 are controlled similarly to the case of the indoor heating and dehumidifying, and each heating element is heated by the heat medium heated by the heat pump system 10 in addition to the heat element's own heat generation. Therefore, the temperature of the heating element can be raised quickly.

Meanwhile, when dehumidification is not selected by the air conditioning controller, the expansion valve C 18 in the heat pump system 10 is closed and the expansion valve A 15 is opened to a preset opening level. The other portions are controlled similarly to the case of the indoor heating and dehumidifying. Thus, the liquid refrigerant in the receiver tank 16 passes through the expansion valve A 15, is sent to the outdoor heat exchanger 13 as a low-pressure low-temperature two-phase refrigerant, absorbs heat from the air supplied by the outdoor fan 14, becomes a gas refrigerant, and returns to the compressor 11 via the four-way valve 12.

Thus, since the refrigerant does not flow through the heat pump indoor heat exchanger 21, there is no cooling of the air supplied indoors and the indoor temperature can be raised quickly. Also, when indoor air conditioning is unnecessary, the indoor fan 61 may be stopped. The air feeding indoors from indoor air conditioning unit 60 is stopped, and the temperature of the heat medium can be raised to a proper temperature more quickly. Therefore, the period when each heating machine has a low temperature such as immediately after startup in winter and the battery has low discharge efficiency due to an insufficient chemical reaction, or when the lubricant in the transmission has a low temperature and high viscosity and the efficiency of the transmission is low, can be shortened.

### (7) Auxiliary Indoor Heating Operation Mode

If indoor heating operation is selected by the air conditioning controller and the outside air temperature detected by the outside air temperature sensor 89 is equal to or lower than a first outside air temperature preset value (for example, 0° C.), the operation is controlled to start a first auxiliary indoor heating operation mode using the heat pump system 10 and an auxiliary indoor heater 70. If the outside air temperature is equal to or lower than a second outside air temperature preset value (for example, −20° C.), the operation is controlled to start a second auxiliary indoor heating operation mode using the auxiliary indoor heater 70 alone.

Referring to FIG. 9 for the explanation, in the first auxiliary indoor heating operation mode, the four-way valve 12 in the heat pump system 10 is switched toward the heating and the suction side of the compressor is connected to the outdoor heat exchanger 13. The three-way valve 22 is switched toward the indoor heating. The expansion valve B 17 is controlled to close. The compressor 11 and the outdoor fan 14 are driven. A fuel (for example, kerosene) is supplied to a combustor 71 of the auxiliary indoor heater 70 and the combustion is started. An auxiliary indoor heating pump (not shown) is driven.

Moreover, the pump 31 of the heat medium circuit 30 and the indoor fan 61 of the indoor air conditioning unit 60 are driven. The air duct switching device A 62 is controlled toward the heat pump indoor heat exchanger 21. The air duct switching device B 63 is controlled toward the heat pump indoor heat exchanger 21. The two-way valve E 44 is controlled to open. The two-way valve F 45 and the two-way valve G 46 are controlled to close. As the compressor 11 is driven, the refrigerant, becomes high-temperature and high-pressure in the compressor 11, passes through the three-way valve 22, is sent to the heat pump indoor heat exchanger 21, heats the air supplied by the indoor fan 61, becomes a saturated liquid at the expansion valve C 18, and is sent to the receiver tank 16.

The liquid refrigerant in the receiver tank 16 passes through the expansion valve A 15, is sent to the outdoor heat exchanger 13 as a low-pressure low-temperature two-phase refrigerant, absorbs heat from the air supplied by the outdoor fan 14, becomes a gas refrigerant, and returns to the compressor 11 via the four-way valve 12. Meanwhile, the heating medium heated by the combustion is made to pass an auxiliary combustion circuit 73 by the auxiliary indoor heating pump of the auxiliary indoor heater 70, is sent to the auxiliary indoor heating intermediate heat exchanger 72 in the intermediate heat exchanger 25, heats the heat medium intermediate heat exchanger 39 in surface contact thereto within the holding frame 27, and returns to the combustor 71.

The heat medium, heated by the heat medium intermediate heat exchanger 39, is sent to each heating element by the pump 31, thus has a further temperature rise, passes through the two-way valve E 44, further heats the air heated by the heat pump indoor heat exchanger 21 at the heat medium second heat exchanger 38 and thus gets cooled, and returns to the heat medium intermediate heat exchanger 39. The air heated by the heat pump indoor heat exchanger 21 and the heat medium second heat exchanger 38 flow indoors and heats the interior.

In the second auxiliary indoor heating operation mode, the compressor 11 and the outdoor fan 14 of the first auxiliary indoor heating operation mode are stopped, and indoor heating is carried out only by the heat medium second heat exchanger 38.

Therefore, even with the use of a heat pump system 10 in which as the outside air temperature becomes lower, the density of the refrigerant at the suction port of the compressor 11 becomes lower and the capability is lowered, by using auxiliary indoor heating by combustion as well, reliable indoor heating capability can be secured even when the outside air temperature is low, and the operation range of the heat pump system 10 can be reduced. High efficient heat pump system can be provided. Moreover, by stopping the heat pump system 10 when the outside air temperature is equal to or lower than the second preset value, which is set at very low temperature, the ratio between the suction pressure and the discharge pressure of the compressor 11 can be kept from becoming too large, and also temperature of compressor 11 can be prevented from becoming too high. Thus a highly reliable heat pump system can be provided.

Also, the fuel of the auxiliary indoor heater 70 is not only kerosene but also may be a fuel that can be easily carried and supplied, such as ethanol or liquefied propane enclosed in a small container. In this case, even if the vehicle has a difficulty in moving due to a certain accident, indoor heating can be carried out simply by supplying the fuel and it is possible for one to stay within the vehicle for a long time even in winter irrespective of the battery level. Moreover, by contacting in surface between the auxiliary indoor heating intermediate heat exchanger 72 and the heat medium intermediate heat exchanger 39 each other using the holding frame 27 in a heat-exchangeable manner, the intermediate heat exchanger can be attached easily even if the vehicle is transported from a region where auxiliary indoor heating is not needed to a region where auxiliary indoor heating is needed.

### REFERENCE SIGNS LIST

10: heat pump system, 11: compressor, 12: four-way valve, 13: outdoor heat exchanger, 14: outdoor fan, 15: expansion valve A, 16: receiver tank, 17: expansion valve B, 18: expansion valve C, 19: heat pump intermediate heat exchanger,
21: heat pump indoor heat exchanger, 22: three-way valve, 23: air conditioning bypass passage, 25: intermediate heat exchanger,
30: heat medium circuit, 31: pump, 32: battery heat exchanger, 33: inverter heat exchanger, 34: voltage converter heat exchanger, 35: motor heat exchanger, 36: transmission heat exchanger, 37: heat medium first heat exchanger, 38: heat medium second heat exchanger, 39: heat medium intermediate heat exchanger,
40: two-way valve A, 41: two-way valve B, 42: two-way valve C, 43: two-way valve D, 44: two-way valve E, 45: two-way valve F, 46: two-way valve G, 47: battery bypass passage, 48: voltage converter bypass passage, 49: transmission bypass passage,
50: indoor air conditioning unit bypass passage,
60: indoor air conditioning unit, 61: indoor fan, 62: air duct switching device A, 63: air duct switching device B,
70: auxiliary indoor heater, 71: combustor, 72: auxiliary indoor heating heat exchanger, 73: auxiliary indoor heating pump, 74: auxiliary indoor heating circuit,
80: heat medium temperature sensor, 81: battery temperature sensor, 82: inverter temperature sensor, 83: voltage converter temperature sensor, 84: motor temperature sensor, 85: transmission temperature sensor, 86: indoor air conditioning unit entrance heat medium temperature sensor, 87: indoor unit inflow air temperature sensor, 88: heat pump intermediate heat exchanger temperature sensor, 89: outside air temperature sensor

1. A vehicle thermal system characterized by comprising:
a heat pump system in which a compressor, a first refrigerant switching unit configured to switch a flowing direction of a refrigerant, an outdoor heat exchanger, a first flow rate control unit, a second flow rate control unit, and a heat pump intermediate heat exchanger are connected in this order, and which has a bypass circuit including a third flow rate control unit between a first expansion valve and a second expansion valve, a heat pump indoor heat exchanger, and a second refrigerant switching unit configured to switch between an discharge side of the compressor and an suction side of the compressor, the heat pump system having the refrigerant flowing therein; and
a heat medium circuit in which a liquid pump, a cooling heat exchanger which cools a heating element installed in the vehicle, a heat medium indoor heat exchanger and a heat medium intermediate heat exchanger are sequentially connected, the heat medium circuit having the heat medium flowing therein, wherein the heat pump intermediate heat exchanger and the heat medium intermediate heat exchanger are provided in a heat-exchangeable manner.

2. The vehicle thermal system according to claim 1, characterized in that:
the heat medium indoor heat exchanger includes a first heat medium indoor heat exchanger, and a second heat medium indoor heat exchanger arranged downstream of an air flow passing through the first heat medium indoor heat exchanger;
an air duct switching unit which directs the air flow passing through the first heat medium indoor heat exchanger, toward the second heat pump indoor heat exchanger or outward, is provided; and
the second heat medium indoor heat exchanger is provided downstream of the air flow passing through the heat pump indoor heat exchanger.

3. The vehicle thermal system according to claim 1, characterized in that:
as a cooling heat exchanger of the heating element, a bypass passage is provided in which a battery heat exchanger, an inverter heat exchanger, a voltage converter heat exchanger, a motor heat exchanger and a transmission heat exchanger are connected in series and in which a flow rate of the heat medium is controlled with respect to each of the battery heat exchanger, the voltage converter heat exchanger and the transmission heat exchanger.

4. The vehicle thermal system according to claim 1, characterized in that:
a second heat medium circuit that is independent of the heat medium circuit where the heat medium flows is provided;
the second heat medium circuit is provided with a combustor which heats a second heat medium flowing through the circuit, and an auxiliary indoor heating heat exchanger; and
the auxiliary indoor heating heat exchanger and the heat medium intermediate heat exchanger are provided in a heat-exchangeable manner.

5. The vehicle thermal system according to claim 4, characterized in that:
the heat pump intermediate heat exchanger, the heat medium intermediate heat exchanger and the auxiliary indoor heating heat exchanger are provided in a heat-exchangeable manner by a pressing force and are configured to be separable from one another when the pressing force is eliminated.
